(19) United States
(12) Patent Application Publication
(10) Pub. No.: US 2015/0176988 A1
(43) Pub. Date: Jun. 25, 2015

(54) METHOD FOR CONTROLLING FUNCTIONS ACCORDING TO DISTANCE MEASUREMENT BETWEEN ELECTRONIC DEVICES AND ELECTRONIC DEVICE IMPLEMENTING THE SAME

(71) Applicant: Samsung Electronics Co., Ltd., Gyeonggi-do (KR)

(72) Inventors: Chihyun Cho, Gyeonggi-do (KR); Changryong Heo, Gyeonggi-do (KR); Kenhyung Park, Gyeonggi-do (KR); Kyunghee Lee, Gyeonggi-do (KR)

(21) Appl. No.: 14/577,970

(22) Filed: Dec. 19, 2014

(30) Foreign Application Priority Data
Dec. 23, 2013 (KR) 10-2013-0160976

(51) Int. Cl. G01B 17/00; G01H 3/10; H04B 11/00

(52) U.S. Cl. CPC G01B 17/00; H04B 11/00; G01H 3/10

(57) ABSTRACT

A method for controlling functions according to a distance measurement between electronic devices and an electronic device implementing the same are disclosed. The method includes transmitting a sound transmission command from a first electronic device to a second electronic device; measuring a distance between the first electronic device and the second electronic device by identifying sound information and reception of sound transmitted from the second electronic device to the first electronic device; and comparing the measured distance and a predetermined user area, and deciding performance of a predefined function corresponding to the user area in the first electronic device.

### CROSS-REFERENCE TO RELATED APPLICATION(S) AND CLAIM OF PRIORITY

The present application is related to and claims the benefit under 35 U.S.C. §119(a) of a Korean patent application No. 10-2013-0160976 filed on Dec. 23, 2013 in the Korean intellectual property office, the entire disclosure of which is hereby incorporated by reference.

### TECHNICAL FIELD

The present disclosure relates to a method for controlling functions according to a distance measurement between electronic devices and an electronic device implementing the same.

### BACKGROUND

Electronic devices such as a smart phone and a tablet PC include an input unit, sensor, display unit, and wireless communication unit. In particular, the wireless communication unit of the electronic device utilizes WiFi and Bluetooth technologies, and thereby data communication between the electronic devices is enabled through the wireless communication unit. A predetermined function can be performed by measuring a distance between two electronic devices through an intensity of signal between the two electronic devices.

### SUMMARY

To address the above-discussed deficiencies, it is a primary object Aspects of the present disclosure are to address at least the above mentioned problems and/or disadvantages to provide at least advantages described below. Accordingly, an aspect of the present disclosure is to provide a method for controlling functions according to a distance measurement between electronic devices and an electronic device implementing the same.

Another aspect of the present disclosure is to provide a method for controlling functions according to a distance measurement between electronic devices and an electronic device implementing the same, in which a distance between two electronic devices is measured and a predefined functions such as locking, unlocking, and relay operations between the two electronic devices can be performed according to the distance.

In accordance with an aspect of the present disclosure, a method for controlling functions according to distance measurement between electronic devices is disclosed. The method includes transmitting a sound transmission command from a first electronic device to a second electronic device; measuring a distance between the first electronic device and the second electronic device by identifying sound information and reception of sound transmitted from the second electronic device to the first electronic device; and comparing the measured distance and a predetermined user area, and deciding performance of a predefined function corresponding to the user area in the first electronic device.

In accordance with another aspect of the present disclosure, a method for controlling functions according to distance measurement between electronic devices is disclosed. The method includes transmitting a sound transmission command from a second electronic device to a first electronic device; transmitting sound information and a sound from the second electronic device; and transmitting a command for stopping the sound transmission from the first electronic device to the second electronic device.

In accordance with another aspect of the present disclosure, an electronic device is disclosed. The electronic device includes a memory configured to store sound information, and reception times of the sound information and a sound; a wireless communication unit configured to transmit the sound information; a sound receiver configured to receive the sound; and a processor configured to transmit a sound transmission command, to measure a distance by identifying the sound information and the sound, and to decide performance of a predefined function by comparing the measured distance and the radius of a user area.

In accordance with another aspect of the present disclosure, an electronic device is disclosed. The electronic device includes a wireless communication unit configured to transmit a sound transmission command and a command for stopping a sound transmission; a sound receiver configured to transmit the sound; and a processor configured to receive the sound transmission command, to transmit the sound information and the sound, and to stop the sound transmission.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of a first electronic device according to an embodiment of the present disclosure;

FIG. 2 is a block diagram illustrating software of a first electronic device according to an embodiment of the present disclosure;

FIG. 3 is a block diagram illustrating a configuration of a second electronic device according to an embodiment of the present disclosure;

FIG. 4 illustrates an intensity of wireless signal and a measurement range of sound signal according to the present disclosure;

FIG. 5 is a flow chart illustrating a method for measuring a distance by using a difference between reception times according to the present disclosure;

FIG. 6 illustrates a procedure of communicating between the first electronic device and the second electronic device according to an embodiment of the present disclosure;

FIG. 7 illustrates a drawing illustrating operation changes of the first electronic device and the second electronic device according to the result of distance measurement in the present disclosure;

FIG. 8 illustrates a drawing illustrating a function of relaying an operation of the second electronic device to the first electronic device according to an embodiment of the present disclosure;

FIG. 9 illustrates a unlocking function of the first electronic device according to an embodiment of the present disclosure; and

FIG. 10 illustrates a drawing illustrating a locking function of the first electronic device according to an embodiment of the present disclosure.

### DETAILED DESCRIPTION

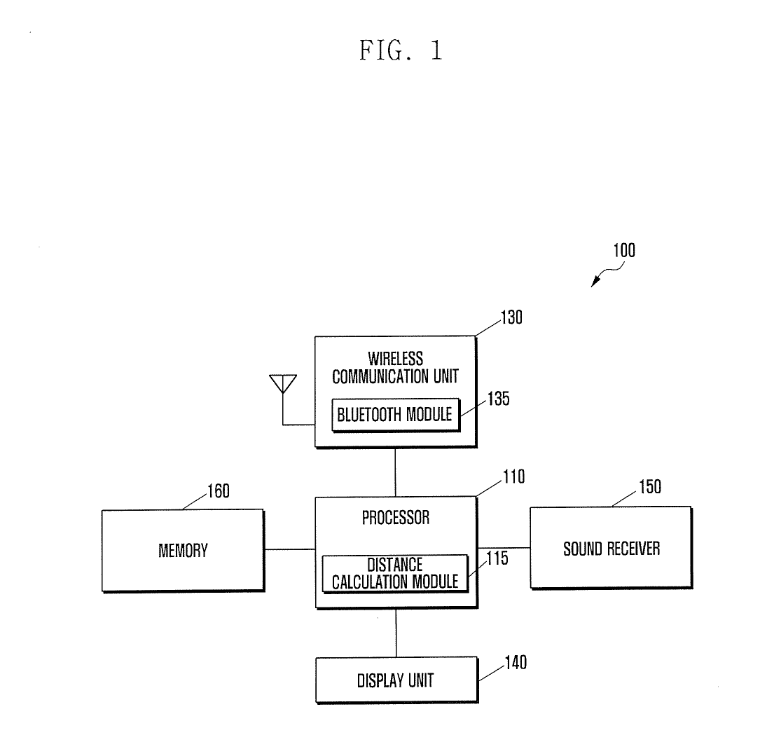

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, embodiments of the disclosure are described in detail with reference to the accompanying drawings. The same reference symbols are used throughout the drawings to refer to the same or like parts. Detailed descriptions of well-known functions and structures incorporated herein may be omitted to avoid obscuring the subject matter of the disclosure.

For the same reasons, some components in the accompanying drawings are emphasized, omitted, or schematically illustrated, and the size of each component does not fully reflect the actual size. Therefore, the present invention is not limited to the relative sizes and distances illustrated in the accompanying drawings.

An electronic device according to the present disclosure may be a device having a communication function, such as a smart phone, tablet PC (personal computer), mobile phone, video phone, e-book reader, desktop PC, laptop PC, netbook computer, PDA (personal digital assistant), PMP (portable multimedia player), MP3 player, mobile medical appliance, electronic bracelet, electronic necklace, electronic appcessory, camera, wearable device, electronic clock, wrist watch, home appliance (for example, refrigerator, air-conditioned, vacuum, oven, microwave oven, washer, and air cleaner), artificial intelligent robot, TV, DVD (Digital Video Disk) player, audio, various medical appliances (for example, MRA (Magnetic Resonance Angiography), MRI (Magnetic Resonance Imaging), CT (Computed Tomography), and ultrasonic scanning machines, navigation device, GPS (Global Positioning System) receiver, EDR (Event Data Recorder), FDR (Flight Data Recorder), set-top box, TV box (for example, Samsung HomeSync™, Apple TV™, or Google TV™), electronic dictionary, automobile infotainment device, electronic equipment for ship (for example, navigation equipment for ship, and gyro compass), avionics, security equipment, electronic clothing, electronic key, camcorder, game consoles, HMD (Head-Mounted Display), flat panel display device, electronic frame, electronic album, furniture or building/structure having a communication function, electronic board, electronic signature receiving device, projector, and their combinations. The electronic device according to the present disclosure is not limited to the aforementioned equipments.

FIG. 1 is a block diagram illustrating a configuration of a first electronic device according to an embodiment of the present disclosure.

Referring to FIG. 1, the first electronic device 100 may be configured with a processor 110, wireless communication unit 130, display unit 140, sound receiver 150, and memory 160.

The processor 110 receives a command from other components (for example, wireless communication unit 130, display unit 140, sound receiver 150, and memory 160), interprets the received command, and performs calculation or data processing according to the interpreted command. The processor 110 may further include a distance calculation module 115. The distance calculation module 115 calculates a distance by using a reception time of sound information (sound configuration and speed stored in a memory) and a reception time of a sound.

A term “module” used in the present disclosure means a unit including at least one of hardware, software, or firmware. For example, the module may be interchangeably used as a unit, logic, logical block, component, or circuit. The module may be the smallest unit or a portion of units. The module may be formed mechanically or electronically. For example, the module according to the present disclosure may be a device for performing a specific function, such as an ASIC (application-specific integrated circuit) chip, FPGAs (field-programmable gate arrays), and programmable-logic device, which are already known or will be developed.

The wireless communication unit 130 performs communications between electronic devices. The wireless communication unit 130 may support a specific local area network communication protocol (for example, Wifi (wireless fidelity), Bluetooth, NFC (near field communication)) or specific network communication (for example, Internet, LAN (local area network), WAN (wire area network), telecommunication network, cellular network, satellite network, or POTS (plain old telephone service)). Another electronic device communicating with the electronic device may be one having the same or different type.

The display unit 140 displays an image or data for a user.

The sound receiver 150 receives a sound transmitted from another electronic device. For example, the sound receiver 150 may be a microphone or a receiver of an ultrasonic sensor. The sound may be an ultrasonic wave or a wave having an audible frequency.

The memory 160 stores commands or data received generated from other components including the processor 110. For example, the memory 160 may include programming modules such as a kernel, middleware, application programming interface (API), and application. Each programming module may be configured with a combination including at least two of software, firmware, and hardware.

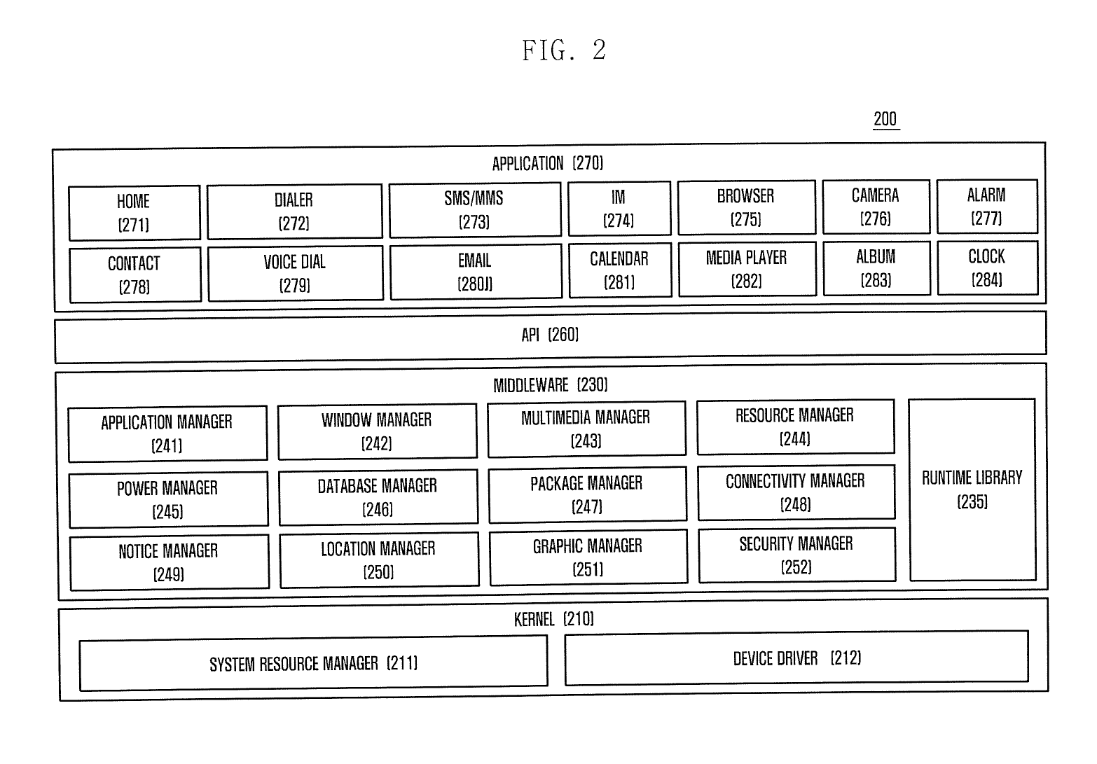

FIG. 2 is a block diagram illustrating a software structure of a first electronic device according to an embodiment of the present disclosure.

The software 200 may be stored in the memory 130 of the electronic device 100 as shown in FIG. 1. At least a portion of the software 200 may be configured with a combination including at least two of software, firmware, and hardware. The software 200 is launched into the hardware 200, and includes an OS (Operating System) and various applications 270 operating under the OS to control the resources of the electronic device 100. For example, the OS may be Android, iOS, Windows, Symbian, Tizen, or Bada. The software 200 may include a kernel 210, middleware 230, API (Application Programming Interface) 260, or application 270.

The kernel 210 may include a system resource manager or a device driver. The system resource manager may include a process manager, memory manager, or file system manager. The system resource manager performs a control, allocation, or recovery of system resources. The device driver may include a display driver, camera driver, Bluetooth driver, shared memory driver, USB driver, keypad driver, WiFi driver, or audio driver. According to an embodiment of the present disclosure, the device driver may include an IPC (Inter-Process Communication) driver (not shown).

The middleware 230 may include a plurality of predetermined modules to provide functions commonly required for the application 270. Further, the middleware 230 may provide an API function so that the application 270 may efficiently use limited system resources in the electronic device. For example, the middleware 230 may include at least one of a runtime library 235, application manager 241, window manager 242, multimedia manager 243, resource manager 244, power manager 245, database manager 246, package manager 247, connectivity manager 248, notification manager 249, location manager 250, graphic manager 251, and security manager 252 as shown in FIG. 2.

The runtime library 235 may include a library module being used by a compiler so that a new function may be added through a programming language while executing the application 270. According to an embodiment of the present disclosure, the runtime library 235 may perform an input/output, memory management, or arithmetic function.

The application manager 241 manages a life cycle of at least one application 270. The windows manager 242 manages GUI resources used by a screen. The multimedia manager 243 checks a format used for playing various media files, and performs encoding or decoding of the media files by using a codec corresponding to the format. The resource manager 244 manages a source code, memory, or storage space of at least one application 270.

The power manager 245 manages a battery or power source through BIOS (Basic Input/Output System), and provides power information required for the operation of the electronic device. The database manager 246 manages generation, search, or modification of a database being used by at least one application 270. The package manager 247 manages installation or update of the application distributed in a package file format.

The connectivity manager 248 manages a wireless connection of WiFi or Bluetooth. The notification manager 249 may display or notify events such as a message arrival, appointment, and proximity in a way of not disturbing a user. The location manager 250 manages location information of the electronic device. The graphic manager 251 manages a graphic effect to be provided for the user or a related user interface. The security manager 252 provides general security functions required for system security or user authentication. According to an embodiment of the present disclosure, if the electronic device 100 is equipped with a telephone, the middleware 230 may further include a telephony manager (not shown) to manage a voice or video telephony function of the electronic device.

The middleware 230 may generate a new middleware module by combining various functions of the aforementioned internal component modules. The middleware 230 may provide a specific module corresponding to the type of operating system in order to provide a differentiated function. Further, the middleware 230 may dynamically delete a portion of the existing components or add a new component. The API 260 is a set of API programming functions, and may be provided in different configurations according to the operating system. For example, the API set may be provided for each platform in case of Android or iOS, and more than one API set may be provided for Tizen.

The application 270 may include a preloaded application or a third party application.

At least a portion of the software 200 may be implemented by a command stored in a computer-readable storage media. When the command is executed by more than one processor, the processors may perform a function corresponding to the command. The computer-readable storage media may be a memory 160. At least a portion of the software 200 may be implemented by the processor 110. In order to perform at least a portion of the software 200, a module, program, routine, sets of instructions and/or process may be included.

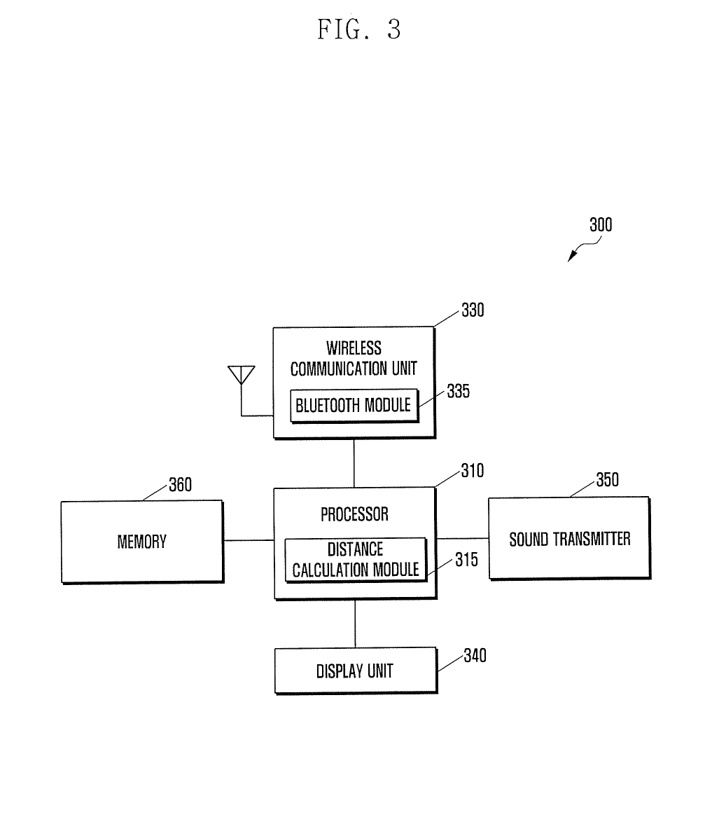

FIG. 3 is a block diagram illustrating a configuration of a second electronic device according to an embodiment of the present disclosure.

Referring to FIG. 3, the second electronic device 300 may be configured with a processor 310, wireless communication unit 330, display unit 340, sound transmitter 350, and memory 360.

The processor 310 receives a command from other components (for example, wireless communication unit 330, display unit 340, sound receiver 350, and memory 360), interprets the received command, and performs calculation or data processing according to the interpreted command. The processor 310 may further include a distance calculation module 315. The distance calculation module 315 calculates a distance by using a reception time of sound information (sound configuration and speed stored in a memory) and a reception time of a sound.

A term “module” used in the present disclosure means a unit including at least one of hardware, software, or firmware. For example, the module may be interchangeably used as a unit, logic, logical block, component, or circuit. The module may be the smallest unit or a portion of units. The module may be formed mechanically or electronically. For example, the module according to the present disclosure may be a device for performing a specific function, such as an ASIC (application-specific integrated circuit) chip, FPGAs (field-programmable gate arrays), and programmable-logic device, which are already known or will be developed.

The wireless communication unit 330 performs communications between electronic devices. The wireless communication unit 330 may support a specific local area network communication protocol (for example, Wifi (wireless fidelity), Bluetooth 335, NFC (near field communication)) or specific network communication (for example, Internet, LAN (local area network), WAN (wire area network), telecommunication network, cellular network, satellite network, or POTS (plain old telephone service)). Another electronic device communicating with the electronic device may be one having the same or different type.

The display unit 340 displays an image or data for a user.

The sound transmitter 350 transmits a sound to another electronic device. For example, the sound transmitter 350 may be a speaker or a transmitter of an ultrasonic sensor. The sound may be an ultrasonic wave or a wave having an audible frequency.

The memory 360 stores commands or data received generated from other components including the processor 310. For example, the memory 360 may include programming modules such as a kernel, middleware, application programming interface (API), and application. Each programming module may be configured with a combination including at least two of software, firmware, and hardware.

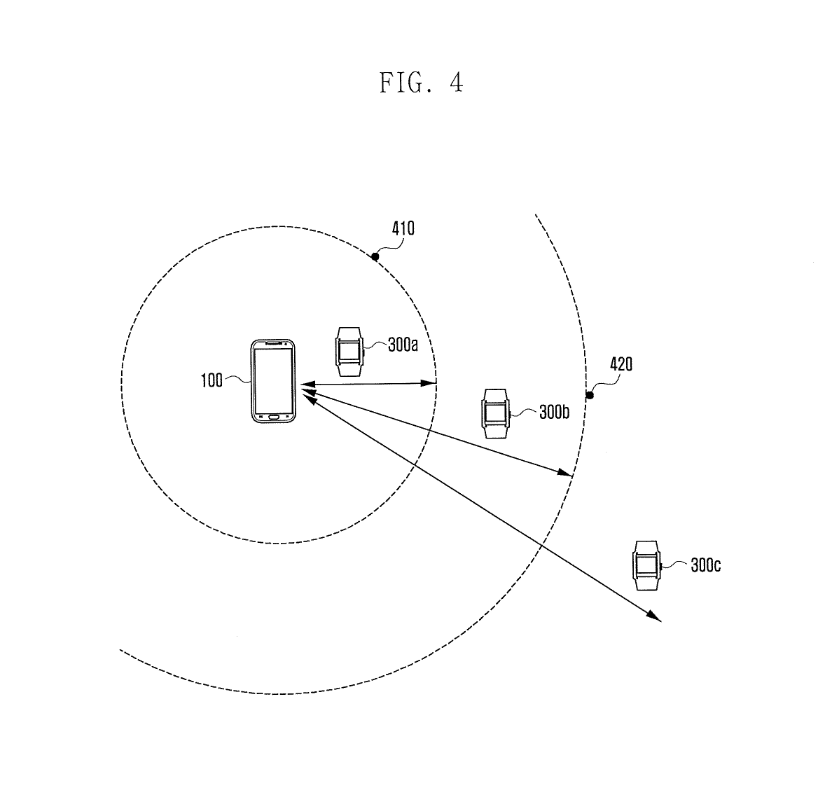

FIG. 4 illustrates an intensity of wireless signal and a measurement range of sound signal according to the present disclosure.

Referring to FIG. 4, the first electronic device 100 may set a user area 410 with a predetermined value (for example, 30 cm). The first electronic device 100 and the second electronic device 300 may communicate respectively through the wireless communication units 130 and 330, and Bluetooth 135 and 335. The processor 110 of the first electronic device 100 may measure a distance to the second electronic device 300 by using communication signal sensitivity (RSSI).

If the second electronic device 300c is located out of a measuring limit line 420, the first electronic device processor 110 may measure the distance by using a communication signal sensitivity. If the second electronic device 300b is located inside the measuring limit line 420, the value measured only with the communication signal sensitivity may generate a deviation.

Accordingly, if the second electronic device 300b is located between the user area 410 and the measuring limit line 420, the processors 110 and 310 respectively of the first electronic device 100 and the second electronic device 300b may transmit a sound signal each other. The processor 110 of the first electronic device 100 may measure the distance to the second electronic device 300 by using a time difference between a reception time of sound information and a reception time of a sound.

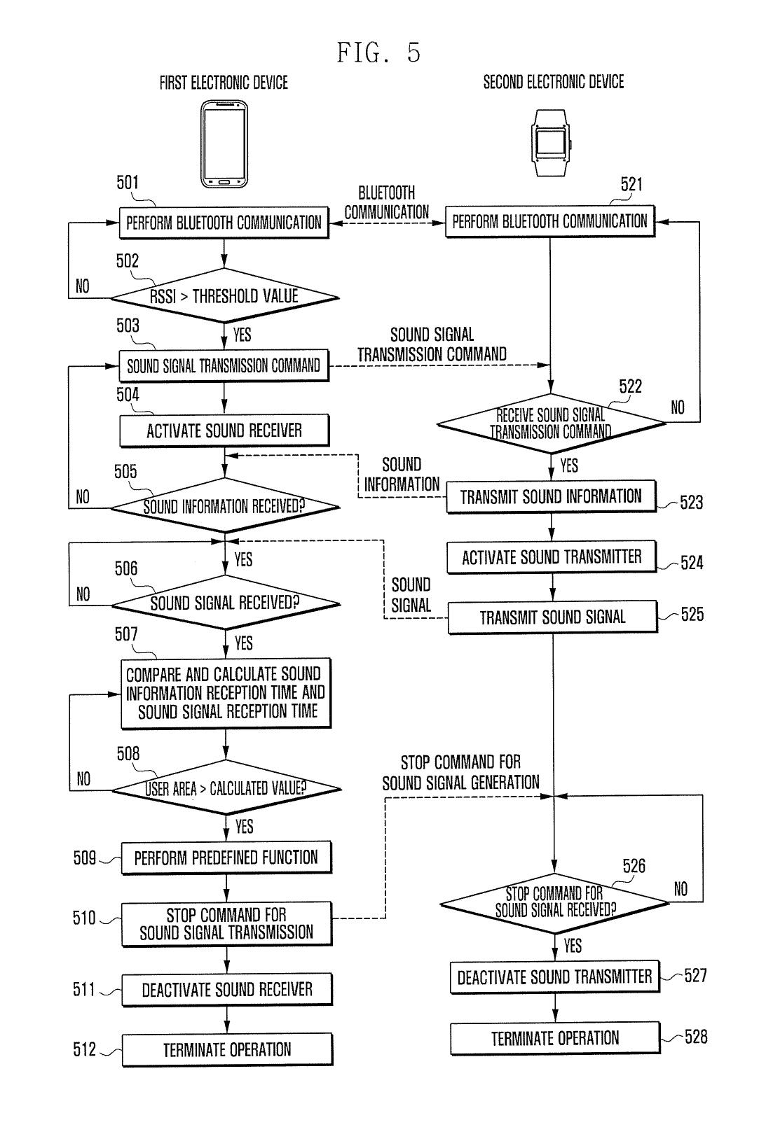

FIG. 5 is a flow chart illustrating a method for measuring a distance by using a difference between reception times according to the present disclosure.

Referring to FIG. 5, the processor 110 of the first electronic device performs a Bluetooth communication by controlling the wireless communication unit 130 at operation 501. The processor 110 may measure the intensity of a wireless signal (RSSI) received from the second electronic device 300. The processor 110 compares the intensity of the wireless signal with a threshold value at operation 502. The threshold value may be the intensity of signal at a measuring limit point of RSSI. If the intensity of wireless signal is smaller than the threshold value, the processor 110 returns to operation 501. The processor 110 controls the Bluetooth module 135 of the wireless communication unit 130 to transmit a sound signal transmission command to the second electronic device 300 at operation 503. The processor 110 activates the sound receiver 150 at operation 504. The processor 110 identifies whether sound information is received through the wireless communication unit 130 at operation 505. If the sound information is not received, The processor 110 returns to operation 503, and controls the Bluetooth module 135 of the wireless communication unit 130 to transmit a sound signal transmission command to the second electronic device 300. If the sound information is received at operation 505, the processor 110 may identify whether a sound signal is received. If the sound signal is not received at operation 505, the processor stands by at operation 506. If the sound signal is received at operation 506, the processor proceeds to operation 507.

The processor 110 calculates a distance by comparing the reception time of the sound information and the reception time of the sound signal at operation 507. If the distance calculated by the processor 110 at operation 508 is greater than the radius of the user area (i.e., if the second electronic device 300 is located out of the user area), the processor 110 returns to operation 507. If the distance calculated by the processor 110 at operation 508 is smaller than the radius of the user area (i.e., if the second electronic device 300 is located in the user area), the processor proceeds to operation 509 and performs a predetermined function.

The processor 110 controls the Bluetooth module 135 of the wireless communication unit (e.g., a transceiver) 130 to transmit a sound signal transmission command to the second electronic device 300 at operation 510.

The processor 110 deactivates the sound receiver 150 at operation 511. The processor 110 transmits a command for stopping the transmission of sound signal at operation 512.

The processor 310 of the second electronic device performs a Bluetooth communication by controlling the wireless communication unit 330 at operation 521. The processor 310 identifies whether a sound signal transmission command is received from the first electronic device 100 through the Bluetooth module 335 of the wireless communication unit 330 at operation 522. If the sound signal transmission command is not received, the processor 310 returns to operation 521. If the sound signal transmission signal is received, the processor 310 proceeds to operation 523. The processor 310 controls the Bluetooth module 335 of the wireless communication unit 330 to transmit sound information to the first electronic device 100 at operation 523. The processor 310 activates the sound transmitter 350 and controls to transmit a sound signal to the first electronic device 100 at operation 525.

The processor 310 identifies whether a command for stopping the transmission of sound signal is received from the first electronic device 100 through the wireless communication unit 330 at operation 526. If the command for stopping the transmission of sound signal has not been received, the processor 310 waits until the command is received. If the command for stopping the transmission of sound signal has been received, the processor 310 proceeds to operation 527. The processor 310 then deactivates the sound transmitter 350 and terminates the procedure at operation 528.

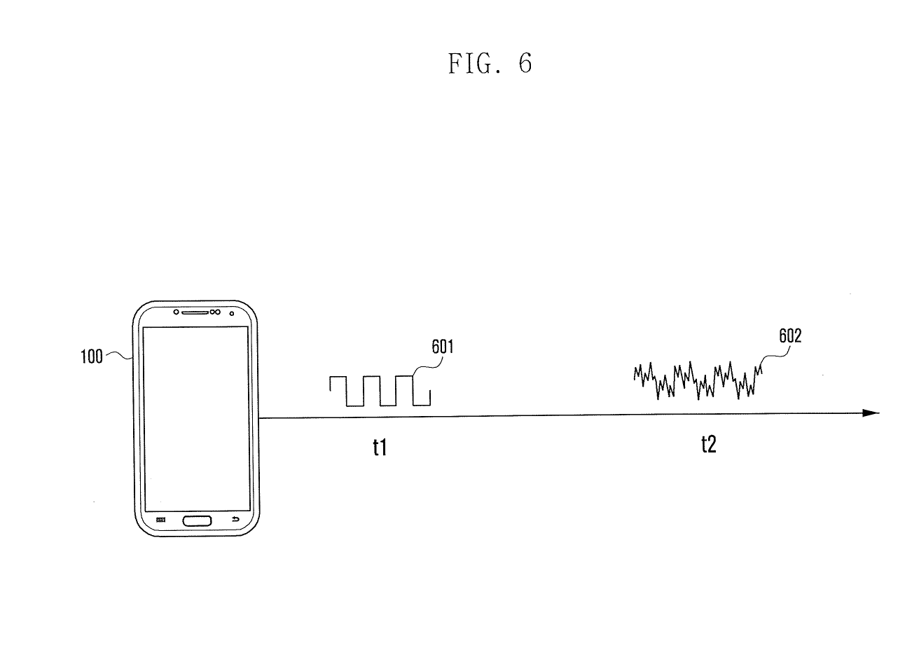

FIG. 6 illustrating a procedure of communicating between the first electronic device and the second electronic device according to an embodiment of the present disclosure.

Referring to FIG. 6, the processor 310 controls the Bluetooth module 335 of the wireless communication unit 330 to transmit sound information 601 (for example, audible frequency). Subsequently, the processor 310 activates the sound transmitter 350 to transmit a sound signal 602.

For example, if the processor 310 transmits only one sound signal 602, the sound receiver 160 may receive another sound signal 602 after an elapsed time. The processor 110 of the first electronic device may have a difficulty in identifying when the sound signal 602 is transmitted from the second electronic device 300.

For this, the processor 310 may control the Bluetooth module 335 to inform the first electronic device 100 with the sound information 601 including a start time of transmission in advance of transmitting the sound signal 602. Right after transmitting the sound information 601, the processor 310 controls the sound transmitter 360 to transmit the sound signal 602. Namely, in order to calculate a distance, the processor 110 may store, in the memory 160, the sound information 602 transmitted through the wireless communication unit 130 and the sound signal 602 received from the sound receiver 160.

When transmitting the sound information 601, the processor 310 may transmit state information of the processor 310. Even though not shown in FIG. 6, the state information of the processor 310 may be indicated as a difference between a transmission time t3 of the sound information 601 and a transmission time t4 of the sound 602. The state information is used to reduce a deviation in calculation if the transmission of sound 601 is delayed or a communication error is generated while the second electronic device 300 transmits the sound 601. The processor 310 controls the wireless communication unit 330 to transmit a difference value between t3 and t4 as the state information to the first electronic device 100. The first electronic device 100 calculates based on the state information of the processor 310 and the difference value between t3 and t4, and thereby may reduce deviations when the first electronic device 100 calculates the distance by using reception times of signals received from the second electronic device 300.

The distance calculation module 115 of the first electronic device 100 may calculate the time difference by comparing the reception time of the sound information 601 and the reception time of sound 602 stored in the memory 160. The distance calculation module 115 may identify the speed of sound from the sound information 601 stored in the memory 160.

The distance may be calculated by using the time difference between the reception time of sound information 601 and the reception time of the sound signal 602, and the speed of sound as shown by the following formula:

r=c×t,

where: r is a distance between first electronic device and second electronic device; c is a speed of sound signal; t is a time difference between reception time of sound information and reception time of sound.

For example, if the speed of the sound signal 602 is 331 m/sec and the time difference between the reception time of sound information 601 and the reception time of sound signal 602 is 1 ms, the distance r becomes 0.3 m (30 cm) by calculating r=331 m/sec×1 ms.

Further, if the speed of the sound signal 602 is 331 m/sec and the time difference between the reception time of sound information 601 and the reception time of sound signal 602 is 3 ms, the distance r becomes 0.99 m (approx. 1 m) by calculating r=331 m/sec×3 ms.

As described above, the distance calculation module 116 may calculate a distance by using the received sound information 601 and sound signal 602.

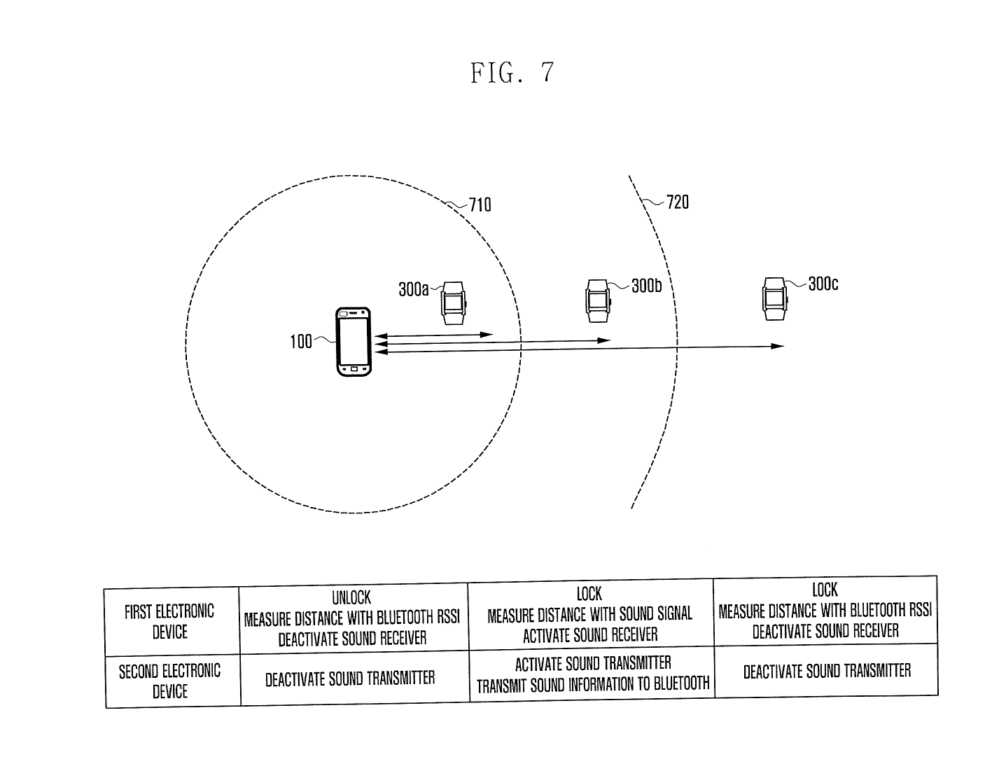

FIG. 7 illustrates a drawing illustrating operation changes of the first electronic device and the second electronic device according to the result of distance measurement in the present disclosure.

Referring to FIG. 7, the first electronic device 100 may set a user area 710 as a virtual area by using a predetermined value (for example, 30 cm). The first electronic device 100 and the second electronic device 300 may communicate through the Bluetooth modules 135 and 335 respectively of each wireless communication unit.

If the second electronic device 300a is located in the user area 710, the first electronic device 100 and the second electronic device 300a may perform the following operations.

The processor 110 of the first electronic device 100 may measure a distance to the second electronic device 300a through the Bluetooth module 135 by using the intensity of communication signal with the second electronic device 300a. At this time, the processor 310 of the second electronic device 300 doesn't transmit a sound 502 for measuring a distance, and thereby the sound transmitter 350 may be deactivated. Further, the processor 110 of the first electronic device 100 may deactivate the sound receiver 150. The processor 110 of the first electronic device 100 may control a security manager 252 to perform a predetermined function.

If the second electronic device 300b is located between the user area 710 and the measuring limit line 720, the first electronic device 100 and the second electronic device 300b may perform the following operations.

The processor 110 of the first electronic device 100 may identify whether the intensity of wireless communication signal is greater than a threshold value by using a signal received from the second electronic device 300b through the Bluetooth module 135. The processor 110 of the first electronic device may transmit a sound transmission command to the second electronic device 300b through the wireless communication unit 130 to measure a distance to the second electronic device 300b. The processor 110 of the first electronic device may activate the sound receiver 150 and control the sound receiver 150 to receive a sound 502. The processor 310 of the second electronic device controls the Bluetooth module 335 of the wireless communication unit to transmit sound information 501. Subsequently, the processor 310 controls the sound transmitter 350 to transmit the sound 502. The processor 110 of the first electronic device measures a distance by calculating a time difference between the reception tie of sound information 501 and the reception time of sound 502 received from the second electronic device 300b. Because the second electronic device 300b is located between the user area 710 and the measuring limit line 720, the first electronic device processor 110 doesn't unlock the display unit 140.

If the second electronic device 300c is located at the outside of the measuring limit line 720, the first electronic device 100 and the second electronic device 300c performs the following operations.

The processor 110 of the first electronic device utilizes the Bluetooth module 135 to measure the distance to the second electronic device 300c by using the intensity of communication signal with the second electronic device 300c. The processor 310 of the second electronic device doesn't transmit the sound 502 to measure the distance, and thereby the sound transmitter 350 is deactivated. Further, the processor 110 of the first electronic device may deactivate the sound receiver 150.

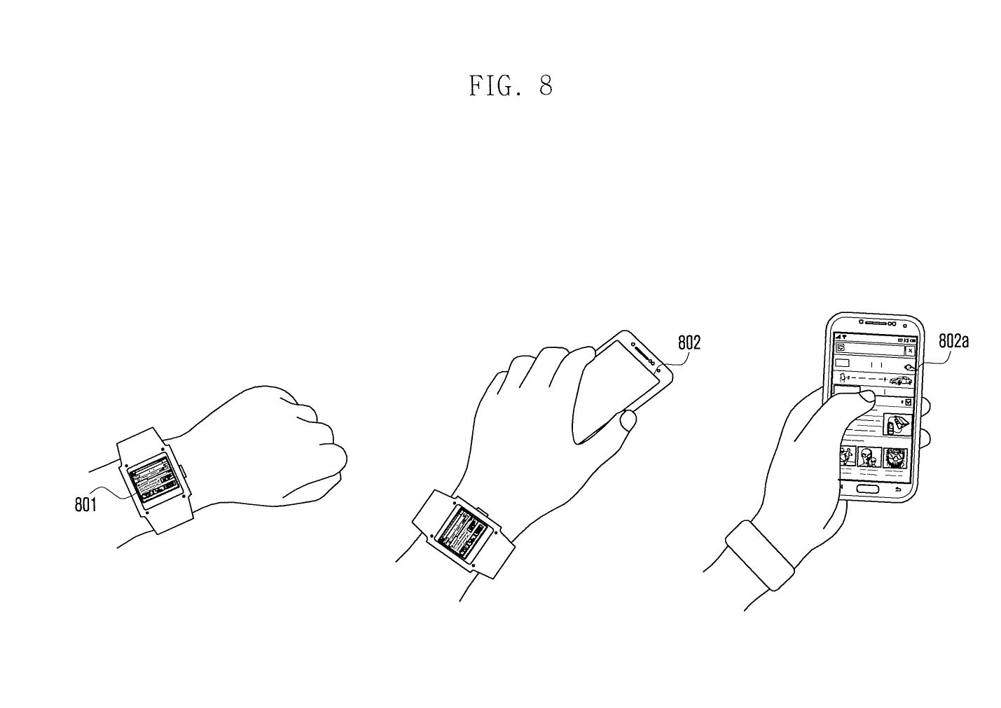

FIG. 8 illustrates a drawing illustrating a function of relaying an operation of the second electronic device to the first electronic device according to an embodiment of the present disclosure.

Referring to FIG. 8, the processor 310 of the second electronic device may control the display unit 340 to output a notice or a message in a screen 801. The first electronic device 100 may be in a sleep mode 802. The second electronic device 300 may be located in a predetermined user area according to the movement of a user. The first electronic device 100 may have the same slope sensor as the second electronic device 300. The processor 110 of the first electronic device may detect a movement of the slope sensor, and release the sleep mode 802 accordingly. Here, the processor 110 of the first electronic device controls the display unit 140 to output an application related to the notice output to the screen 801 of the second electronic device in a screen 802a. For example, the processor 310 of the second electronic device may control the display unit 340 to output a notice of message reception. In this case, if the slope sensor of the second electronic device 300 and the first electronic device 100 become to have the same value (if the user hold the first electronic device 100 in a hand), the processor 110 of the first electronic device detects a movement of the slope sensor, and controls the display unit 140 to output a message chatting windows related to the notice of message reception in the screen 802a of the first electronic device 100. In some embodiments, the mobile device is awaken from a sleeping mode and turns on a screen if the slope is within a slope range, when the distance is within a distance range. In another embodiment, the mobile device enters into a sleeping mode including off a screen if the slope is within a slope range, even when the distance is within a distance range.

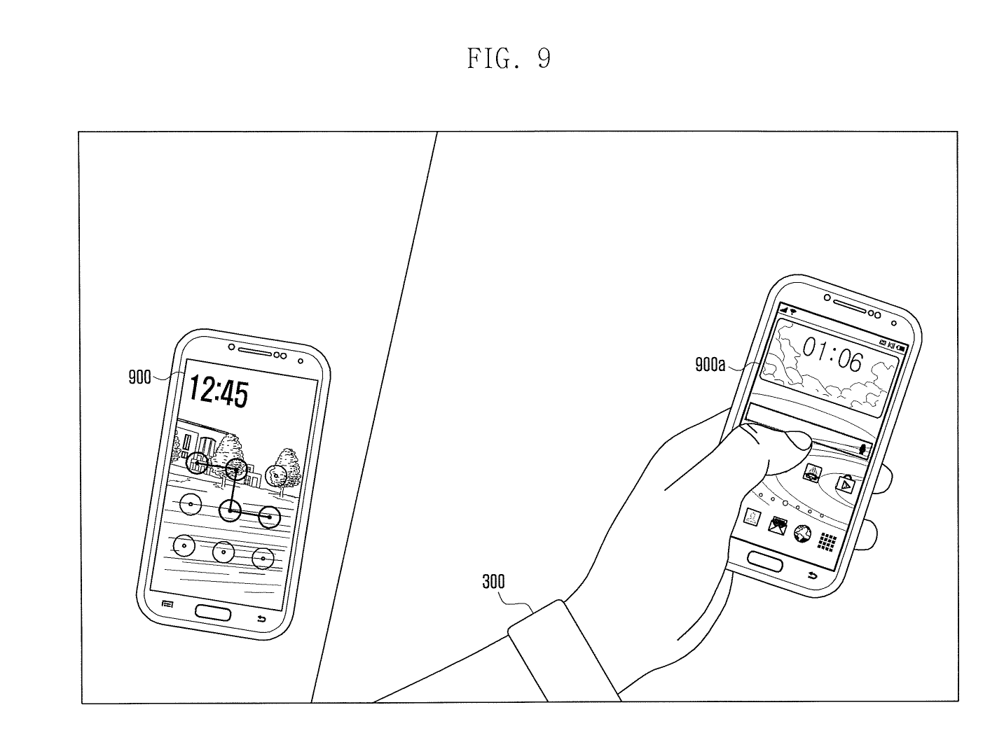

FIG. 9 illustrates an unlocking operation of the first electronic device according to an embodiment of the present disclosure.

Referring to FIG. 9, the processor 110 of the first electronic device may control the display unit 140 to display a locking screen 900. The processor 110 may set a user area as a virtual area by using a predetermined value. The second electronic device 300 may be located in the user area set by the processor 110 of the first electronic device according to the movement of the user. If the processor 110 of the first electronic device detects the second electronic device 300 located in the user area, the processor 110 controls the display unit 140 to output an unlocking screen 900a. The first electronic device 100 performs unlocking without requiring an unlocking operation such as an input of a pattern or a password. In some embodiments, the mobile device is awaken from a sleeping mode and turns on a screen if the measured distance is less than a threshold distance. In another embodiment, the mobile device enters into a sleeping mode including off a screen if the measured distance is greater than a threshold distance.

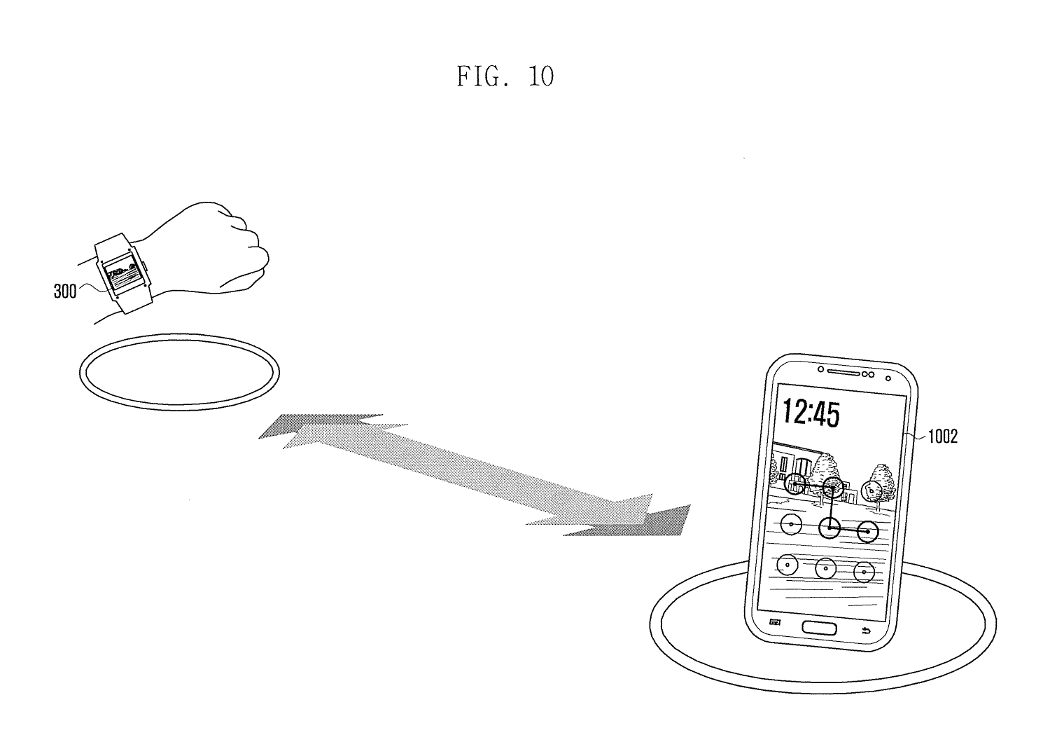

FIG. 10 illustrates a locking function of the first electronic device according to an embodiment of the present disclosure.

Referring to FIG. 10, the processor 110 of the first electronic device may set a user area as a virtual area by using a predetermined value. The second electronic device 300 may be located at the outside of the user area set by the processor 110 of the first electronic device. If the processor 110 of the first electronic device detects the second electronic device 300 located at the outside of the user area, the processor 110 controls the display unit 140 to output a lock screen 1002 in order to perform a predetermined unlocking function. A locking operation of the first electronic device 100 may be performed without requiring a locking operation such as an input of lock setting or power key.

As described above, the method according to the present disclosure may be implemented as a program command executable in various computers and stored in a storage media readable by the computers. Here, the storage media may include a program command, data file, and data structure. The program command may be one specially designed for the present disclosure or one disclosed in the art of computer software. Further, the storage media may include a magnetic media such as a hard disk, floppy disk, and magnetic tape, optical media such as a CD-ROM and a DVD, magneto-optical media such as a floptical disk, and hardware such as a ROM, RAM, and flash memory. The program command may include a high-level language code executable by a computer having an interpreter as well as a machine language code generated by a compiler.

According to the present disclosure, a predefined function may be decided to perform according to a distance measured between electronic devices.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for controlling functions according to distance measurement between electronic devices, the method comprising:
transmitting a sound transmission command from a first electronic device to a second electronic device;
measuring a distance between the first electronic device and the second electronic device by identifying sound information and reception of sound transmitted from the second electronic device to the first electronic device; and
comparing the measured distance and a predetermined user area, and deciding performance of a predefined function corresponding to the user area in the first electronic device.

2. The method of claim 1, wherein the transmitting of the sound transmission command is performed if the intensity of a signal transmitted from the second electronic device to the first electronic device is greater than a threshold value.

3. The method of claim 1, wherein the measuring of the distance comprises calculating the distance by identifying the reception time of the sound information and the reception time of the sound.

4. The method of claim 3, wherein the calculating of the distance comprises calculating the distance by using a time difference between the reception time of the sound information and the reception time of the sound.

5. The method of claim 1, wherein the user area has a distance set so that the first electronic device is displaced from the second electronic device maintaining a predetermined distance.

6. The method of claim 1, wherein the deciding whether to perform the predefined function comprises performing the predetermined function in the first electronic device if the measured distance is smaller than the radius of the user area.

7. The method of claim 1, wherein the deciding of the performance comprises relaying a function operating in the second electronic device to the first electronic device if the measured distance is smaller than the radius of the user area.

8. A method for controlling functions according to distance measurement between electronic devices, the method comprising:
transmitting a sound transmission command from a second electronic device to a first electronic device;
transmitting sound information and a sound from the second electronic device; and
transmitting a command for stopping the sound transmission from the first electronic device to the second electronic device.

9. The method of claim 8, wherein the transmitting of the sound and sound information comprises transmitting the sound information and transmitting the sound sequentially.

10. An electronic device comprising:
a memory configured to store sound information, and reception times of the sound information and a sound;
a wireless communication unit configured to transmit the sound information;
a sound receiver configured to receive the sound; and
a processor configured to transmit a sound transmission command, to measure a distance by identifying the sound information and the sound, and to decide performance of a predefined function by comparing the measured distance and the radius of a user area.

11. The electronic device of claim 10, wherein the processor activates or deactivates the sound receiver.

12. The electronic device of claim 10, wherein the sound transmission command is transmitted if the intensity of a received signal is greater than a threshold value.

13. The electronic device of claim 10, wherein the distance is calculated by identifying the reception time of the sound information and the reception time of the sound.

14. The electronic device of claim 11, wherein the processor calculates the distance by using a time difference between the reception time of sound information and reception time of sound.

15. The electronic device of claim 10, wherein the user area has a distance set so that the first electronic device is displaced from the second electronic device maintaining a predetermined distance.

16. The electronic device of claim 10, wherein the processor performs a predefined function if the measure distance is smaller than the radius of the user area.

17. The electronic device of claim 10, wherein the processor relays a function operating in the second electronic device to the first electronic device if the measured distance is smaller than the radius of the user area.

18. An electronic device comprising:
a wireless communication unit configured to transmit a sound transmission command and a command for stopping a sound transmission;
a sound receiver configured to transmit the sound; and
a processor configured to receive the sound transmission command, to transmit the sound information and the sound, and to stop the sound transmission.

19. The electronic device of claim 18, wherein processor activates or deactivates the sound receiver.

20. The electronic device of claim 18, wherein processor sequentially transmits the sound information and transmitting the sound.
